(19) United States
(12) Patent Application Publication
(10) Pub. No.: US 2009/0102237 A1
(43) Pub. Date: Apr. 23, 2009

(54) Vehicle Body for a Motor Vehicle

(75) Inventor: Mario List, Remseck (DE)

Correspondence Address: CROWELL & MORING LLP;INTELLECTUAL PROPERTY GROUP, P.O. BOX 14300, WASHINGTON, DC, 20044-4300, US

(73) Assignee: Daimler AG, Stuttgart (DE)

(21) Appl. No.: 11/996,467

(22) PCT Filed: Jul. 8, 2006
(86) PCT No.: PCT/EP06/06709

§ 371 Date: Jun. 11, 2008

(30) Foreign Application Priority Data
Jul. 23, 2005 (DE) 102005034470.4

(51) Int. Cl. B62D 33/063

(52) U.S. Cl. 296/190.07

(57) ABSTRACT

A vehicle body for a commercial, vehicle includes a driver's cab mounted at least indirectly on a vehicle frame. The driver's cab is movable by a frontal impact force acting on the driver's cab in the vehicle longitudinal direction from an initial position to a deflected position, and the center of gravity of the driver's cab is arranged higher in the deflected position than in the initial position.

### BACKGROUND AND SUMMARY OF THE INVENTION

This invention relates to a vehicle body for a commercial vehicle including a driver's cab mounted at least indirectly on a vehicle frame.

A vehicle body of this type is known, for example, from a configuration in which a driver's cab is mounted on a vehicle frame via a front pivot bearing. This driver's cab is additionally mounted on the vehicle frame via a rear driver's cab mounting, viewed in the vehicle longitudinal direction. This rear driver's cab mounting has a drive device with which the driver's cab can be tilted about the front pivot axis, for example for purposes of maintenance of the engine arranged below the cab.

A device for mounting a unit, for example a radiator, is known from German document DE 102 60 787 B3. The device is so designed that, in the event of an accident, the unit, i.e. for example the radiator, is moved in the direction of the rear of the vehicle and at the same time is lowered. By means of such a mounting, crash-box parts provided adjacent to the mounting can be deformed in an unobstructed manner.

Starting from the above, it is the object of the present invention to provide a vehicle body for a commercial vehicle which offers good passive safety in the event of a frontal impact.

This object is achieved according to the invention by having the driver's cab movable, by an impact force acting on the driver's cab from the front, in the vehicle longitudinal direction from an initial position to a deflected position, with the center of gravity of the driver's cab being arranged higher in the deflected position than in the initial position.

The mounting of the driver's cab according to the invention makes it possible to convert the kinetic energy arising in the event of a frontal impact into potential energy. Through the raising of the center of gravity of the driver's cab, large quantities of energy can be dissipated with comparatively small changes of the position of the center of gravity of the driver's cab.

An embodiment of the invention provides that the driver's cab is mounted on or fixed to at least one connecting element. The connecting element is mounted on the vehicle frame via a bearing. With such a connecting element, the movement path followed by the driver's cab in moving from the initial position to the deflected position can be defined especially well.

If the above-mentioned bearing between the connecting element and the vehicle frame is in the form of a pivot bearing, the connecting element can be swiveled from the initial position to a deflected position. The driver's cab is entrained as a result of the mounting on or fixing to the connecting element, and the center of gravity therefore is moved to a higher position.

Alternatively or additionally, the driver's cab may be mounted on the vehicle frame via at least one ramp or cam element. The ramp or cam element rises in the vehicle vertical direction when viewed from front or rear in the vehicle longitudinal direction. In this case the driver's cab is preferably mounted positively on the vehicle frame and is moved rearwardly along the ramp or cam element by the impact force acting on the driver's cab and simultaneously upwardly as a result of the rearwardly rising shape of the ramp or cam element. This movement from front to rear and at the same time from below to above converts kinetic energy into potential energy.

An especially advantageous embodiment of the invention provides that the movement of the driver's cab from the initial position to the deflected position is restrained by movement-restraining means. The movement-restraining means may be formed by the driver's cab, the connecting element, the ramp or cam element and/or the vehicle frame. However, they may also be formed by at least one additional component which comprises, for example, a cable, a sheet-metal element and/or a strap.

All or some of the components mentioned may be deformed during the movement of the driver's cab from the initial position to the deflected position. Depending on the design of the components, it can thereby be achieved that a deflection of the driver's cab from the initial position to the deflected position is triggered only when given impact forces are exceeded. After the movement of the driver's cab has been triggered, the deformation of the components serves to make possible additional dissipation of energy.

The components mentioned may also be in frictional engagement with a respective friction partner in order to be able to prevent triggering of the movement of the driver's cab from the initial position to the deflected position up to the attainment of predetermined impact forces and/or to dissipate energy with the aid of the frictional engagement after triggering of the movement. This energy dissipation takes place simultaneously with the energy dissipation accompanying the increase of the potential energy of the driver's cab.

An especially advantageous embodiment of the invention provides that destructible elements are provided which, in their undestroyed state, fix the driver's cab in the initial position and, in the destroyed state, make possible a movement of the driver's cab to the deflected position. With the aid of these destructible elements, the driver's cab can be retained securely on the vehicle frame provided a predetermined impact force is not exceeded. Upon exceeding of this predetermined impact force, the destructible elements are destroyed, whereby the driver's cab is released to move from the initial position to the deflected position. This movement may be accompanied by the deformations and/or frictional engagements discussed above.

If the bearing between the connecting element and the vehicle frame has a higher destruction resistance than the destructible elements, it is possible that, in the event of an impact of the driver's cab with an obstacle with only small impact forces, only the driver's cab and the destructible elements are affected, while the vehicle frame can remain undamaged. In this case only the destructible elements and the damaged parts of the driver's cab need to be exchanged. Shear pins may appropriately be used for such destructible elements.

According to a further aspect of the invention, deflection of the driver's cab from the initial position to the deflected position takes place in a plurality of stages. These states are associated, for example, with different deformation and/or frictional resistances, so that progressive dissipation of energy is made possible.

An especially preferred exemplary embodiment of the present invention is explained in more detail below with reference to the appended drawings.

### BRIEF DESCRIPTION OF THE DRAWINGS

FIG. 1 shows a portion of the vehicle body of a commercial vehicle with a driver's cab mounted on a vehicle frame and with the driver's cab in an initial position; and

FIG. 2 shows the vehicle body according to FIG. 1 with the driver's cab in a deflected position.

### DETAILED DESCRIPTION OF THE INVENTION

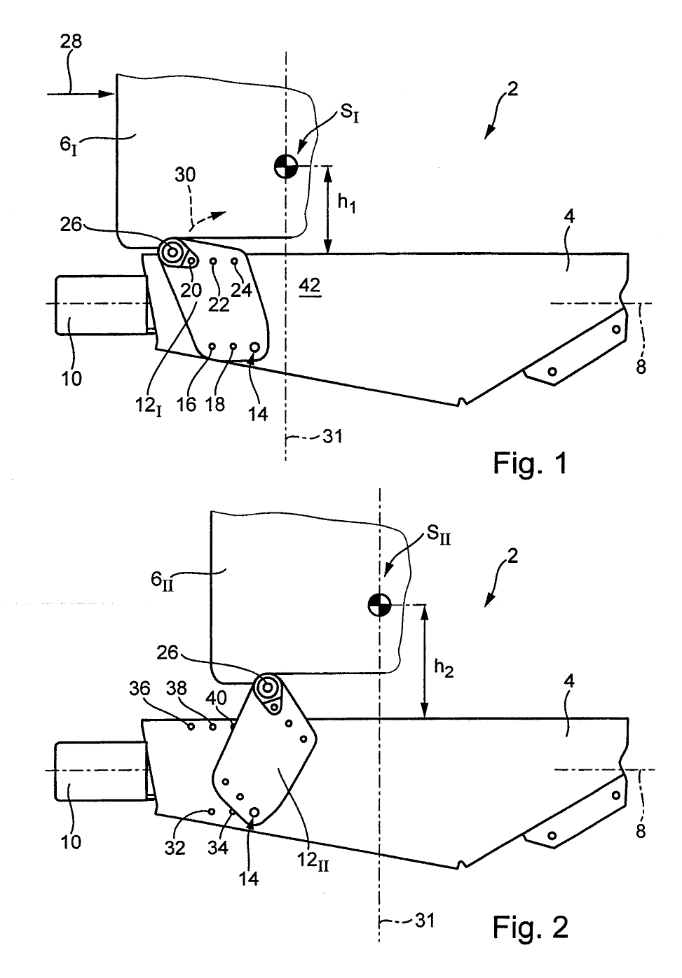

FIG. 1 shows a portion of the vehicle body of a commercial vehicle, which vehicle body is denoted as a whole by the reference symbol 2. This portion shows in a schematic representation the front, lower part of a commercial vehicle in a side view.

The vehicle body 2 comprises a vehicle frame 4 on which a driver's cab 6, a portion of which is shown, is mounted. FIG. 1 shows one of the two side members of the vehicle frame 4, which side member extends in the vehicle longitudinal direction 8 and ends at a front bumper 10 at the front end of the vehicle body 2.

The driver's cab 6 is mounted on the vehicle frame 4 via two plate-like connecting elements, a connecting element 12 arranged on the left-hand side, in the travel direction, being shown in the drawing. The following description applies correspondingly to the right-hand connecting element, in the direction of travel, which is not illustrated. The connecting element 12 has a bearing 14 in the form of a pivot bearing which connects the connecting element 12 swivelably to the vehicle frame 4. The bearing 14 includes a pin (not shown in detail) which is dimensioned sufficiently large to have high shear resistance. Two pins 16 and 18 are arranged forwardly of the bearing 14, in the vehicle longitudinal direction 8, and laterally adjacent thereto. Corresponding pins 20, 22 and 24 are provided at the upper end, in FIG. 1, of the connecting element 12. The pins 16 to 24 connect the connecting element 12 to the vehicle frame 4. These pins are dimensioned small in comparison to the pin of the bearing 14.

The connection between the driver's cab 6 and the connecting element 12 is effected by a driver's cab bearing 26.

In the event of a collision with a rear end of another vehicle, for example a parked trailer platform, the driver's cab 6 is subjected to an impact load which is represented symbolically by an impact force 28 in FIG. 1. The impact force 28 is transmitted via the driver's cab 6 and the driver's cab bearing 26 to the connecting element 12 and is finally applied to the vehicle frame 4. The pins 16 to 24 are so designed that they fail, that is shear, whereas both the driver's cab bearing 26 and the bearing 14 remain intact. As a result of the shearing of the pins 16 to 24, the connecting element 12 can execute a swiveling movement indicated by the arrow 30. The driver's cab 6 is thereby moved from the initial position 6_{I} represented in FIG. 1 to the deflected position 6_{II} represented in FIG. 2. As this happens the center of gravity S of the driver's cab 6 is raised, so that the latter, starting from the initial position S_{I} shown in Fig., adopts the position S_{II} shown in FIG. 2.

The distance h_{I} of the center of gravity S_{I} from the upper boundary of the vehicle frame 4, in the vehicle vertical direction 31, has increased to the distance h_{II} in accordance with FIG. 2, so that the kinetic energy imparted to the vehicle body 2 by the impact force 28 has been converted at least partially into potential energy.

FIG. 2 shows pin receptacles 32, 34, 36, 38 and 40 in which the pins 16 to 24 are received in the initial position I of the connecting element 12. After the shearing of the pins 16 to 24, the connecting element 12 can adopt the position II shown in FIG. 2.

The region into which the connecting element 12 swivels back from position I to position II is denoted by the reference symbol 42 in FIG. 1. In order to convert the kinetic energy not only partially into potential energy during the deflection of the driver's cab 6 from the position 6_{I} to the position 6_{II}, as the center of gravity is moved from the position S_{I} to the higher position S_{II}, the connecting element 12 may swivel back from the initial position 12_{I} to the deflected position 12_{II} with deformation of the vehicle frame 4. As this happens the connecting element 12 does not swivel without resistance rearwardly, in the vehicle longitudinal direction 8, about the bearing 14, but does so with contact and deformation of the vehicle frame 4. During the movement of this element, therefore, dents, for example, may be impressed by the connecting element 12 in the vehicle frame 4.

Additionally, the connecting element 12 may be attached to the vehicle frame 4 by means of a cable. The cable is untensioned in the initial position I of the connecting element 12 and tensioned during the movement of the connecting element 12 to the deflected position II, whereby a part of the kinetic energy is dissipated through elongating deformation of the cable.

1-14. (canceled)

15. A vehicle body for a commercial vehicle, comprising:
a driver's cab, and
a vehicle frame on which the driver's cab is mounted at least indirectly,
wherein the driver's cab is movable by a frontal impact force acting on the driver's cab in a vehicle longitudinal direction from an initial position to a deflected position, and
wherein the center of gravity of the driver's cab is arranged higher in the deflected position than in the initial position.

16. The vehicle body as claimed in claim 15, wherein the driver's cab is mounted or fixed to at least one connecting element, and wherein the connecting element is mounted to the vehicle frame via a bearing.

17. The vehicle body as claimed in claim 16, wherein the bearing is a pivot bearing.

18. The vehicle body as claimed in claim 16, wherein the driver's cab is mounted on the vehicle frame via at least one ramp or cam element, and wherein the ramp or cam element rises in the vehicle vertical direction when viewed from front to rear in the vehicle longitudinal direction.

19. The vehicle body as claimed in claim 18, wherein the movement of the driver's cab from the initial position to the deflected position is restrained by at least one movement-restraining element.

20. The vehicle body as claimed in claim 19, wherein the at least one movement-restraining element is formed by at least one of the driver's cab, the connecting element, the ramp or cam element, and the vehicle frame.

21. The vehicle body as claimed in claim 19, wherein the at least one movement-restraining element is formed by at least one additional component.

22. The vehicle body as claimed in claim 21, wherein the additional component comprises at least one of a cable, a sheet-metal element, and a strap.

23. The vehicle body as claimed in claim 21, wherein movement of the driver's cab from the initial position to the deflected position takes place with deformation of at least one of the driver's cab, the connecting element, the ramp or cam elements, the vehicle frame, and the additional component.

24. The vehicle body as claimed in claim 21, wherein movement of the driver's cab from the initial position to the deflected position takes place with frictional engagement of at least one of the driver's cab, the connecting element, the ramp or cam elements, the vehicle frame, and the additional component.

25. The vehicle body as claimed in claim 16, further comprising destructible elements which, in an undestroyed state, fix the driver's cab in the initial position and, in a destroyed state, permit a movement of the driver's cab to the deflected position.

26. The vehicle body as claimed in claim 25, wherein the bearing between the connecting element and the vehicle frame has a higher resistance to destruction than the destructible elements.

27. The vehicle body as claimed in claim 25, wherein the destructible elements are formed by shear pins.

28. The vehicle body as claimed in claim 15, wherein deflection of the driver's cab from the initial position to the deflected position takes place in a plurality of stages.

29. The vehicle body as claimed in claim 16, wherein deflection of the driver's cab from the initial position to the deflected position takes place in a plurality of stages.

30. The vehicle body as claimed in claim 17, wherein deflection of the driver's cab from the initial position to the deflected position takes place in a plurality of stages.

31. The vehicle body as claimed in claim 18, wherein deflection of the driver's cab from the initial position to the deflected position takes place in a plurality of stages.

32. The vehicle body as claimed in claim 19, wherein deflection of the driver's cab from the initial position to the deflected position takes place in a plurality of stages.

33. The vehicle body as claimed in claim 20, wherein deflection of the driver's cab from the initial position to the deflected position takes place in a plurality of stages.

34. The vehicle body as claimed in claim 21, wherein deflection of the driver's cab from the initial position to the deflected position takes place in a plurality of stages.
